(19) United States
(12) Patent Application Publication
(10) Pub. No.: US 2008/0187326 A1
(43) Pub. Date: Aug. 7, 2008

(54) IMAGE FORMING APPARATUS AND IMAGE FORMING SYSTEM COMPRISING THE SAME AND PRINTING METHOD THEREOF

(75) Inventor: Dong Myong SHIN, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/025,331

(22) Filed: Feb. 4, 2008

(30) Foreign Application Priority Data
Feb. 6, 2007 (KR) 2007-11912
Jan. 21, 2008 (KR) 2008-6056

(51) Int. Cl. G03G 15/00; G06F 3/12

(52) U.S. Cl. 399/8; 358/1.15

(57) ABSTRACT

A network image forming apparatus and a printing method thereof in an image forming system automatically change print concentration according to a type of print data and printing the print data so as to provide convenience to a user. The printing method of the network image forming apparatus connected to at least one terminal device via a network includes receiving print data from the at least one terminal device, obtaining print output information using the type of the received print data, and changing a print concentration of the print data according to the obtained print output information and printing the print data.

### CROSS-REFERENCE TO RELATED APPLICATIONS

This application claims priority under 35 U.S.C. §119(a) from Korean Patent Application No. 2007-11912, filed on Feb. 6, 2007 in the Korean Intellectual Property Office and No. 2008-0006056, filed on Jan. 21, 2008 in the Korean Intellectual Property Office, the disclosure of which is incorporated herein by reference.

### BACKGROUND OF THE INVENTION

1. Field of the Invention

The present general inventive concept relates to a network image forming apparatus and a printing method thereof, and more particularly, to a network image forming apparatus to change a print concentration according to a type of print data and to print the print data, and a printing method thereof.

2. Description of the Related Art

Generally, a network printer connected to a plurality of terminal devices via a network stores print data transmitted from the terminal devices in a memory installed in the network printer and then sequentially prints the print data.

Meanwhile, a user of the network printer changes an option of a print driver and more particularly a print concentration, according to the type of a printed matter such that the network printer adequately prints various types of print data. For example, if the user prints a printed matter of a text format, such as a word file, the print concentration is increased such that characters printed on the printed matter are clearly recognized and, if the user prints a printed matter of an image format, such as a JPEG file, the print concentration is decreased in order to maintain the fineness of the image.

However, in such a conventional network printer, if any one user sets a print option, a printing operation is performed according to the print option set by the user unless another user changes the print option. Accordingly, an optimal printing operation may not be performed.

For example, if a user who mainly prints a text file in the network printer connected to a plurality of terminal devices increases the print concentration of the network printer and then another user prints an image file, an image may be thickly printed.

Accordingly, there is a need for a network printer for changing a print concentration according to the type of a printed matter of each user and printing print data.

### SUMMARY OF THE INVENTION

The present general inventive concept provides a network image forming apparatus to automatically change a print concentration according to a type of print data and to print the print data, and a printing method thereof.

Additional aspects and/or advantages of the present general inventive concept will be set forth in part in the description which follows and, in part, will be obvious from the description, or may be learned by practice of the general inventive concept.

The foregoing and/or other aspects and utilities of the present general inventive concept can be achieved by providing a printing method of a network image forming apparatus connected to at least one terminal device via a network, the printing method including receiving print data from the at least one terminal device, obtaining print output information using a type of the received print data, and changing a print concentration of the print data according to the obtained print output information to print the print data.

The method may further include storing the type of the print data printed by the at least one terminal device.

The obtaining of the print output information may include obtaining the print output information using the type of the print data which was previously printed by the at least one terminal device.

Print data received from a new terminal device may be printed without obtaining the print output information thereof.

The method may further include determining whether the type of the received print data is a text format or an image format. The print output information may include the percentage of print data of a text format and the percentage of print data of an image format.

The printing of the print data may include printing the print data at a print concentration higher than a normal print concentration if the percentage of the print data of the text format is larger than that of the print data of the image format, printing the print data at a print concentration lower than the normal print concentration if the percentage of the print data of the text format is smaller than that of the print data of the image format, and printing the print data at the normal print concentration if the percentage of the print data of the text format is equal to that of the print data of the image format.

The method may further include displaying the obtained print output information or the changed print concentration.

The changing of the print concentration may include manually changing the print concentration of the print data regardless of the obtained print output information and printing the print data.

The foregoing and/or other aspects and utilities of the present general inventive concept may also be achieved by providing a network image forming apparatus connected to at least one terminal device via a network, the network image forming apparatus including an interface unit to receive print data from the at least one terminal device, a control unit to obtain print output information using a type of the received print data, and a printing unit to change a print concentration of the print data according to the obtained print output information and to print the print data.

The network image forming apparatus may further include a memory to store the type of the print data printed by the at least one terminal device.

The control unit may determine whether the type of the received print data is a text format or an image format.

The print unit may print the print data at a print concentration higher than a normal print concentration if the percentage of the print data of the text format is larger than that of the print data of the image format, print the print data at a print concentration lower than the normal print concentration if the percentage of the print data of the text format is smaller than that of the print data of the image format, and print the print data at the normal print concentration if the percentage of the print data of the text format is equal to that of the print data of the image format.

The network image forming apparatus may further include a display unit to display the obtained print output information or the changed print concentration.

The foregoing and/or other aspects and utilities of the present general inventive concept may also be achieved by providing a computer-readable medium to contain computer-readable codes as a program to execute a method of an image forming system, the method including receiving print data from the at least one terminal device, obtaining print output information using a type of the received print data, and changing a print concentration of the print data according to the obtained print output information and printing the print data.

The foregoing and/or other aspects and utilities of the present general inventive concept may also be achieved by providing an image forming system including a terminal device to generate print data; and an image forming apparatus to print the print data, wherein print output information is obtained using a type of the print data, and a print concentration is changed according to the print output information such that the image forming apparatus prints the print data according to the changed print concentration.

The terminal device may transmit the print output information to the image forming apparatus.

The image forming apparatus may obtain the print output information using type of previous print data, and change the print concentration according to the print output information and the type of the print data.

The terminal device may include a plurality of terminal devices, the print output information may be obtained to correspond to each of the terminal devices to generate the print data, and the image forming apparatus may print the print data according to the print information to the corresponding terminal device when receiving the print data from the corresponding terminal device.

The terminal device may include a plurality of terminal devices, the print output information may include a plurality of print output information to correspond to the respective terminal devices, and the image forming apparatus may print the print data according to the corresponding print output information.

The foregoing and/or other aspects and utilities of the present general inventive concept may also be achieved by providing an image forming apparatus including a printing unit to print current print data, and a control unit to obtain print output information according to one or more types of one or more previous print data, to change a print concentration according to the print output information and a type of the current print data, and to control the printing unit to print the print data according to the changed print concentration.

The type of the print data may include one of the one or more types of the one or more previous print data, and the print output information may include a ratio between the one or more types of the one or more previous print data which have been printed.

The one or more types of the one or more previous print data may include at least one of a dark mode, a middle mode, and a light mode each to represent one of density, amount, and concentration of a developer or an ink.

The previous print data may include first print data received from a first terminal device, and second print data received from a second terminal device, the print output information may include first print output information to correspond to the first print data and the first terminal device and second print output information to correspond to the second print data and the second terminal device, and the control unit may controls the printing unit to print the current print data according to the first print information and the type of the current data when the current print data is received from the first terminal device, and to print the current print data according to the second print information and the type of the current data when the current print data is received from the second terminal device.

The control unit may receive the current from one of plurality of terminal devices, and may control the printing unit to print the current print data according to the type of the current print data and the print output information to correspond to the one of the plurality of terminal devices.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a network image forming apparatus according to an embodiment of the present general inventive concept;

FIG. 2 is a block diagram illustrating a network image forming apparatus connected to at least one terminal device via a network according to an embodiment of the present general inventive concept;

FIG. 3 is a view illustrating an example of print output information stored in a memory illustrated in FIG. 1 or 2;

FIG. 4 is a flowchart illustrating a printing method of a network image forming apparatus according to an embodiment of the present general inventive concept; and

FIG. 5 is a flowchart illustrating a printing method of a network image forming apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below to explain the present general inventive concept by referring to the figures.

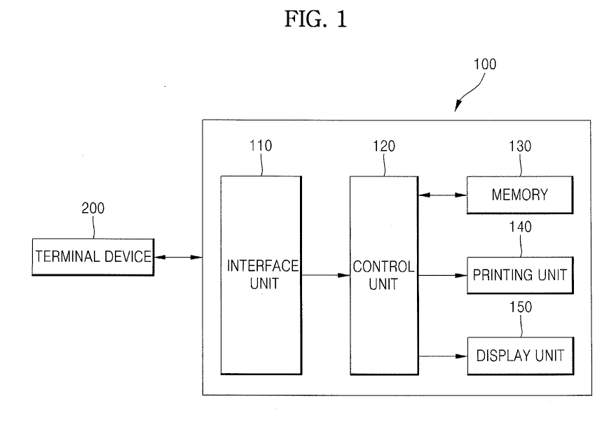

FIG. 1 is a block diagram illustrating an image forming system having an image forming apparatus 100 according to an embodiment of the present general inventive concept. The image forming apparatus 100 may be a network image forming apparatus 100 including an interface unit 110, a control unit 120, a memory 130, a printing unit 140 and a display unit 150.

The interface unit 110 transmits/receives data to/from a terminal device 200 and receives print data from the terminal device 200. The interface unit 110 may be realized by a serial interface such as a universal serial bus (USB) interface, a parallel interface or a network interface.

The control unit 120 controls the overall operation of the network image forming apparatus 100 and determines if a type of the print data is a text format or an image format. Here, the print data of the text format includes an MS Word file, an MS Excel file, a Hunmin Jeongeum file, a Hangul file, etc., and the print data of the image format includes a JPEG file, a TIFF file, etc. Here, Hunmin Jeongeum file and the Hangul file may be a type of a Korean language file.

The control unit 120 obtains print output information using the type of the print data. Here, the print output information is obtained by calculating percentages of the types of the print data, which was previously printed in the network image forming apparatus 100 by the terminal device 200, that is, by measuring the percentage of the print data of the text format and the percentage of the print data of the image format. That is, the print output information indicates whether a user mainly prints the print data of the text format or the print data of the image format, on the basis of the type of the print data which was printed in the past or before the printing of current print data.

In more detail, the control unit 120 divides the print data, which was previously printed, by a predetermined unit (e.g., 10 sheets of paper), calculates the percentage of the print data of the text format and the percentage of the print data of the image format in the divided print data, and outputs the print output information.

For example, if the predetermined unit is 10 sheets of paper and one sheet of paper is one piece of print data, the control unit 120 records the type of the print data of each sheet in a list. When the number of pieces of print data recorded in the list becomes 10, the percentage of the print data of the text format and the percentage of the print data of the image format are calculated so as to obtain the print output information.

At this time, the control unit 120 checks the total number of pieces of print data of the text format and the total number of pieces of print data of the image format in the 10 pieces of print data and measures the percentage of the print data of the text format and the percentage of the print data of the image format using the checked total numbers. For example, if the number of pieces of print data of the text format is 8 and the number of pieces of print data of the image format is 2 in the 10 pieces of print data, the percentage of the print data of the text format is 8/10×100%=80% and the percentage of the print data of the image format is 2/10×100%=20%.

Accordingly, the information output information includes the percentage of the print data of the text format of 80% and the percentage of the print data of the image format of 20%.

Meanwhile, instead of the above-described print output information (information obtained using the type of the print data which was previously printed), information obtained using the type of the print data which will be printed (information obtained using the type of the print data which is currently received) may be used as the print output information.

That is, when the print data is received from the terminal device 200 via the interface unit 110, the control unit 120 checks the type of the print data before printing the print data and obtains the print output information on the basis of the checked type. This print output information indicates whether any user mainly prints the data of the text format or the data of the image data.

In more detail, the control unit 120 checks the type of the print data received from the terminal device 200, divides the print data by a predetermined unit according to the checked type of the print data, calculates the percentage of the print data of the text format and the percentage of the print data of the image format in the divided print data according to the divided print data, and then outputs the print output information. For example, if the predetermined unit is 10 sheets of paper and one sheet of paper is one piece of print data, the control unit 120 checks and stores the type of the print data received from the terminal device 200. When the number of pieces of stored print data becomes 10, the percentage of the print data of the text format and the percentage of the print data of the image format are calculated so as to obtain the print output information.

The control unit 120 controls a print concentration as a portion of a print option to vary according to the obtained print output information. That is, the control unit 120 controls the print concentration to “dark,” “medium,” or “light” on the basis of the print output information such that a print quality of the print data is optimized.

Here, the “dark,” “medium,” or “light” represents a dark mode, a medium mode, or a light mode to correspond to a density, amount, or thickness of a print material, such as ink, toner, or developer. That is, the “dark,” “medium,” or “light” may represent a dark mode to print the print data with a first density, amount, or thickness of the printing material, a medium mode to print the print data with a second density, amount, or thickness of a print material, or a light mode to print the print data with a third density, amount, or thickness of a print material.

The configuration of a printing operation to adjust the print concentration will be described in detail in the printing unit 140.

The memory 130 stores the type of the print data which was previously printed or the print data which is currently received. That is, the memory 130 stored the type of the print data when the print data was previously printed or immediately stores the type of the print data when the print data is currently received, thereby obtaining the print output information. The memory 130 is included in the image forming apparatus 10 as a module to input and/or output information, such as a DRAM, a SDRAM, a RDRAM, a DDRAM or a SRAM.

The printing unit 140 changes the print concentration according to the obtained print output information and prints the print data in the printing operation.

In more detail, the printing unit 140 prints the print data at a print concentration higher than a normal print concentration if the percentage of the print data of the text format is larger than that of the print data of the image format in the print output information. That is, since it is preferable that the print data of the text format is printed in the dark mode in order to recognize characters, the printing unit 140 prints the print data at the print concentration higher than the normal print concentration which is initially set if the percentage of the print data of the text format is larger than that of the print data of the image format.

In contrast, if the percentage of the print data of the text format is smaller than that of the print data of the image format in the print output information, the printing unit 140 prints the print data at a print concentration lower than the normal print concentration. That is, if the print data including an image is printed in the dark mode, the image is printed with the first density, amount, or thickness of a print material, land thus the print quality of the image deteriorates. Accordingly, in order to maintain the print quality of the image, the printing unit 140 prints the print data at the print concentration lower than the normal print concentration in the printing operation.

Here, the normal print concentration may be one of print options to print the print data when the print data is a mixed of an image and a text. The normal print concentration may be the medium mode between the dark mode and the light mode. The normal print concentration may be a reference concentration to be compared with at least one of the dark concentration of the dark mode and the light concentration of the light mode so as to control the quality of the printed print data.

The display unit 150 displays the obtained print output information or the changed print concentration and includes an LCD, a PDP, a TFT, an organic EL display device, or a CRT. The display unit 150 may be included in the network image forming apparatus 100 or may be included in another device connected to the network image forming apparatus 100.

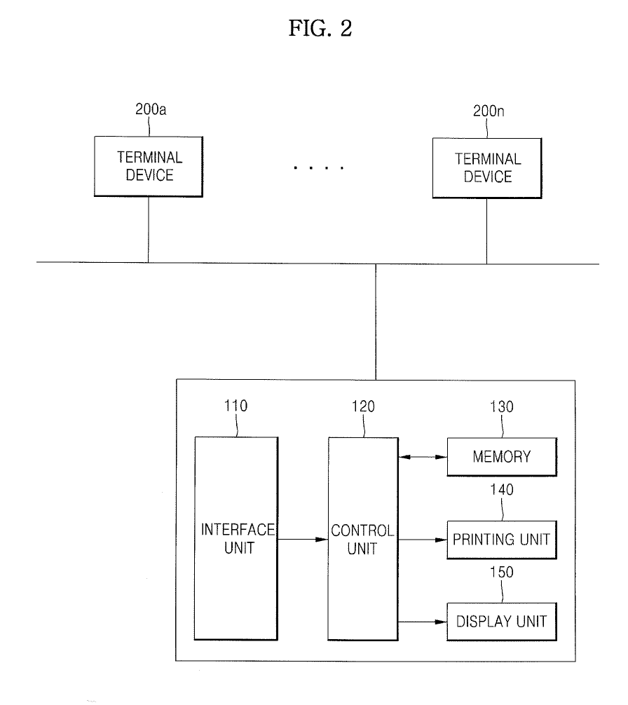

FIG. 2 is a block diagram illustrating an image forming system having a network image forming apparatus connected to at least one terminal device via a network according to an embodiment of the present general inventive concept.

Hereinafter, the components of the image forming apparatus of FIG. 2 having similar functions to those illustrated in FIG. 1 are denoted by same reference numerals, and thus the detailed description thereof will be omitted.

The network image forming apparatus 100 is connected to a plurality of terminal devices 200a to 200n and includes an interface unit 110, a control unit 120, a memory 130, a printing unit 140 and a display unit 150.

The interface unit 110 transmits/receives data to/from the terminal devices 200a to 200n and receives print data from the terminal devices 200a to 200n.

The control unit 120 controls the overall operation of the network image forming apparatus 100 and determines if the type of the print data is a text format or an image format according to the plurality of terminal devices 200a to 200n.

The control unit 120 obtains print output information using the type of the print data according to the plurality of terminal devices 200a to 200n. Here, the print output information is obtained by calculating percentages of the types of the print data, which were previously printed in the image forming apparatus by the plurality of terminal devices 200a to 200n in one or more previous printing operations, that is, by measuring the percentage of the print data of the text format and the percentage of the print data of the image format to correspond to each of the terminal devices 220a to 200n. That is, the print output information indicates whether a user of the corresponding terminal device 200a to 200n mainly prints the data of the text format or the data of the image format, on the basis of the type of the print data which was printed in the past.

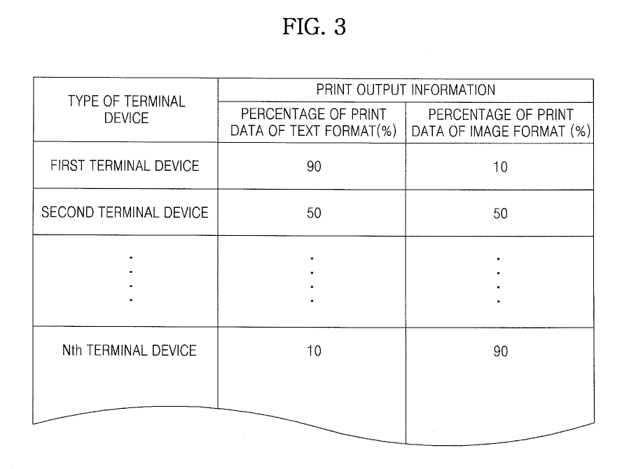

For example, referring to FIG. 3, with respect to a first terminal device 200a, if the number of pieces of print data of the text format is 9 and the number of pieces of print data of the image format is 1 in 10 pieces of print data which were printed in the past in the image forming apparatus by the first terminal device 200a, the percentage of the print data of the text format is 9/10×100%=90% and the percentage of the print data of the image format is 1/10×100%=10%. Accordingly, the print output information of the first terminal device 200a includes the percentage of the print data of the text format of 90% and the percentage of the print data of the image format of 10%. With respect to a second terminal device 200b, if the number of pieces of print data of the text format is 5 and the number of pieces of print data of the image format is 5 in 10 pieces of print data which were printed in the past, the percentage of the print data of the text format is 5/10×100%=50% and the percentage of the print data of the image format is 5/10×100%=50%. Accordingly, the print output information of the second terminal device 200b includes the percentage of the print data of the text format of 50% and the percentage of the print data of the image format of 50%.

Meanwhile, instead of the above-described print output information, information obtained using the type of the print data which is currently received may be used as the print output information.

The control unit 120 controls the print concentration to vary according to the obtained print output information.

The memory 130 stores the type of the print data which was previously printed or is currently received, according to the terminal devices 200a to 200n. That is, the memory 130 stores the type of the print data and stores the print output information which is generated using the type of the print data according to the plurality of terminal devices 200a to 200n, such that the printing operation is performed with a print option suitable for each of the terminal devices 200a to 200n using the print output information stored in the memory 130 when the print data is printed by the printing unit 140.

The printing unit 140 changes the print concentration according to the obtained print output information and prints the print data according to the changed print output information. That is, the printing unit 140 prints the print data at a print concentration higher than a normal print concentration if the percentage of the print data of the text format is larger than that of the print data of the image format in the print output information of the first terminal device 200a.

In contrast, if the percentage of the print data of the text format is smaller than that of the print data of the image data in the print output information of an N^{th} terminal device 200n, the printing unit 140 prints the print data at a print concentration lower than the normal print concentration.

Accordingly, since the print concentration can be automatically adjusted according to the print characteristics of the user, the printing operation can be performed in an optimal status.

The printing unit 140 prints print data received from a new terminal device without obtaining the print output information.

The display unit 150 displays the print output information or the print concentrations of the plurality of terminal devices 200a to 200n and includes an LCD, a PDP, a TFT, an organic EL display device, or a CRT. The display unit 150 may be included in the network image forming apparatus 100 or may be included in another device connected to the network image forming apparatus 100.

Although, in the present embodiment, the print output information is obtained using the type of the print data in the network image forming apparatus, the print output information may be obtained by the plurality of terminal devices.

For example, the image forming apparatus may transmit the print output information to the terminal device when receiving the print data from the terminal device and printing the received print data on a print medium, such as a sheet of paper. The terminal device may store the received print output information which can be used for the terminal device to generate and transmit next print data to be printed in the image forming apparatus.

When the image forming apparatus is set as one of a dark mode and a light mode and receives and prints the print data, the image forming apparatus may print the print data in the other one of the dark mode and the light mode according to a type of the print data and the print output information regardless of the set dark mode.

It is possible that when the terminal deice does not set or transmit the print option to be used to print the print data in the image forming apparatus, the image forming apparatus my print the print data according to the print output information. That is, the image forming apparatus prints the print data according to the print output information as an optimized print option in the printing operation. Here, the image forming apparatus may include a scanning unit connectable to the interface unit 110 or the control unit 120 to scan a document to generate the print data. It is possible that the scanning unit may be operated as the terminal device.

Hereinafter, a method of automatically adjusting the print concentration of the print data using the type of the print data, which was previously printed, and the network image forming apparatus of the present invention and printing print data will be described.

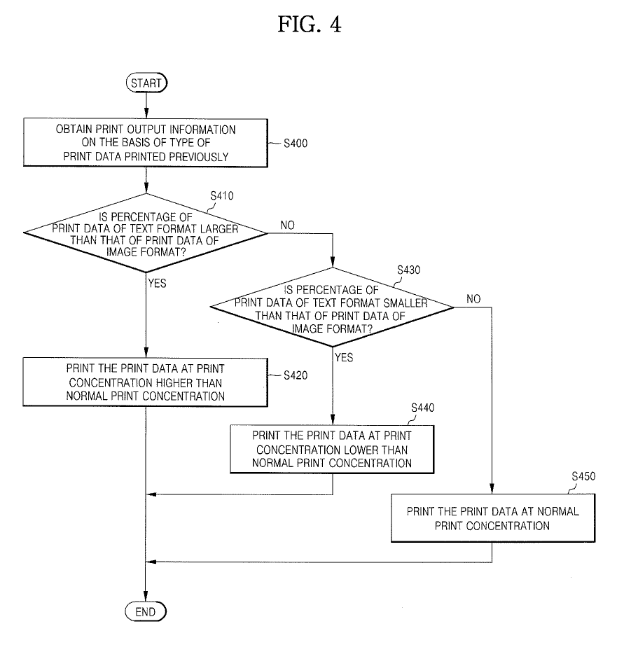

FIG. 4 is a flowchart illustrating a printing method of a network image forming apparatus in an image forming system according to an embodiment of the present general inventive concept. Referring to FIGS. 1 and 4, the control unit 120 of the network image forming apparatus 100 obtains the print output information on the basis of the type of the print data which was previously printed by each of the plurality of terminal devices 200a to 200n in operation 400. That is, since the type of the print data is stored in the memory 130, the control unit 120 obtains the print output information using the type of the print data stored in the memory 130.

Next, it is determined whether the percentage of the print data of the text format is larger than that of the print data of the image format in the print output information in operation 410. If it is determined that the percentage of the print data of the text format is larger than that of the print data of the image format in a case of Yes in operation 410, then new print data is printed at the print concentration higher than the normal print concentration in operation 420.

In contrast, if it is determined that the percentage of the print data of the text format is not larger than that of the print data of the image format in a case of No in operation 410, then it is determined whether the percentage of the print data of the text format is smaller than that of the print data of the image format in operation 430.

As a result, if it is determined that the percentage of the print data of the text format is smaller than that of the print data of the image format in a case of Yes in operation 430, then the new print data is printed at the print concentration lower than the normal print concentration in operation 440.

If it is determined that the percentage of the print data of the text format is equal to that of the print data of the image format In a case of No in operation 430, then the new print data is printed at the normal print concentration in operation 450.

Hereinafter, a method of automatically adjusting the print concentration of the print data using the type of the print data, which is currently received, and the network image forming apparatus of the present invention and printing print data will be described.

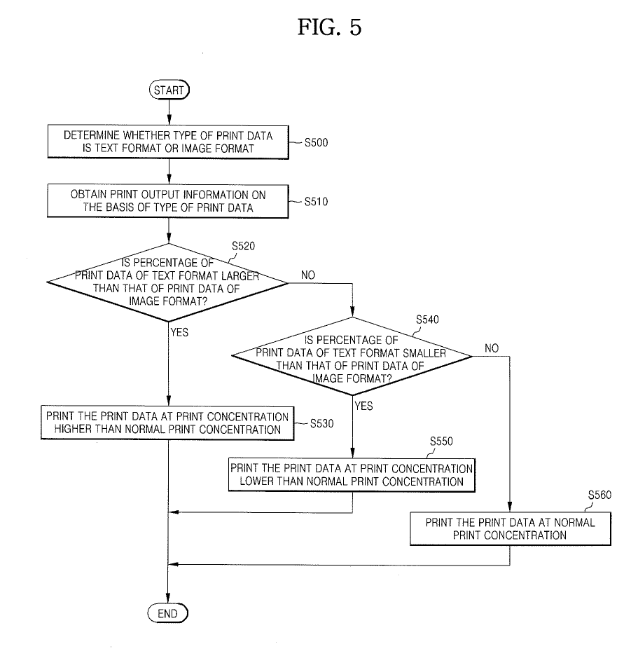

FIG. 5 is a flowchart illustrating a printing method of a network image forming apparatus in an image forming system according to an embodiment of the present general inventive concept. Referring to FIGS. 2 and 5, the control unit 120 of the network image forming apparatus 100 determines whether the type of the print data received from each of the plurality of terminal devices 200a to 200n is the text format or the image format (500).

Then, the print output information is obtained using the type of the print data in operation 510.

Subsequently, it is determined whether the percentage of the print data of the text format is larger than that of the print data of the image format in the print output information (520). If it is determined that the percentage of the print data of the text format is larger than that of the print data of the image format in a case of Yes in operation 520), then the print data is printed at the print concentration higher than the normal print concentration in operation 530.

In contrast, if it is determined that the percentage of the print data of the text format is not larger than that of the print data of the image format in a case of No in operation 410, then it is determined whether the percentage of the print data of the text format is smaller than that of the print data of the image format in operation 540.

As a result, if it is determined that the percentage of the print data of the text format is smaller than that of the print data of the image format in a case of Yes in operation 540, then the print data is printed at the print concentration lower than the normal print concentration in operation 550.

If it is determined that the percentage of the print data of the text format is equal to that of the print data of the image format in a case of No in operation 540, then the print data is printed at the normal print concentration in operation 560.

In the present general inventive concept, the print concentration of the print data may be manually changed by a user as the print output information. That is, if the user wants to change the print concentration of the print data, the user inputs the print concentration and the control unit 120 changes the print concentration of the print data to the input print concentration as a portion of the print output information.

As described above, in the network image forming apparatus and the printing method using the same according to the present general inventive concept, the print concentration is automatically changed according to the print output information generated using the type of the print data, thereby efficiently printing the print data.

If the network image forming apparatus connected to at least one terminal device is used, the print concentration can be automatically adjusted according to the print characteristics of the user and thus the printing operation can be performed in an optimal status. That is, since the network image forming apparatus is used by many users, it is difficult to set a constant print concentration. However, according to the present invention, it is possible to solve the troublesomeness that the user should directly set the print option (print concentration) whenever the user prints print data.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it would be appreciated by those skilled in the art that changes may be made in these embodiments without departing from the principles and spirit of the general inventive concept, the scope of which is defined in the claims and their equivalents.

What is claimed is:

1. A printing method of an image forming apparatus connected to at least one terminal device via a network, the printing method comprising:
receiving print data from the at least one terminal device;
obtaining print output information using a type of the received print data; and
changing a print concentration of the print data according to the obtained print output information to print the print data according to the changed print concentration.

2. The method of claim 1, further comprising:
storing the type of the print data printed by the at least one terminal device.

3. The method of claim 2, wherein the obtaining of the print output information comprises obtaining the print output information using the type of the print data which was previously printed in the image forming apparatus by the at least one terminal device.

4. The method of claim 1, wherein print data received from a new terminal device is printed without obtaining new print output information thereof.

5. The method of claim 1, further comprising:
determining whether the type of the received print data is a text format or an image format.

6. The method of claim 1, wherein the print output information includes a first percentage of the print data of a text format and a second percentage of the print data of an image format.

7. The method of claim 6, wherein the printing of the print data comprises:
printing the print data at the print concentration higher than a normal print concentration if the percentage of the print data of the text format is larger than that of the print data of the image format,
printing the print data at the print concentration lower than the normal print concentration if the percentage of the print data of the text format is smaller than that of the print data of the image format, and
printing the print data at the normal print concentration if the percentage of the print data of the text format is equal to that of the print data of the image format.

8. The method of claim 1, further comprising:
displaying the obtained print output information or the changed print concentration.

9. The method of claim 1, wherein the changing of the print concentration comprises manually changing the print concentration of the print data regardless of the obtained print output information to print the print data according to the manually changed print concentration.

10. An image forming apparatus connected to at least one terminal device via a network, the image forming apparatus comprising:
an interface unit to receive print data from the at least one terminal device;
a control unit to obtain print output information using the type of the received print data; and
a printing unit to change a print concentration of the print data according to the obtained print output information and to print the print data according to the changed print concentration.

11. The image forming apparatus of claim 10, further comprising a memory to store the type of the print data printed by the at least one terminal device.

12. The image forming apparatus of claim 10, wherein the control unit determines whether the type of the received print data is a text format or an image format.

13. The image forming apparatus of claim 12, wherein the print unit:
prints the print data at a print concentration higher than a normal print concentration if the percentage of the print data of the text format is larger than that of the print data of the image format;
prints the print data at a print concentration lower than the normal print concentration if the percentage of the print data of the text format is smaller than that of the print data of the image format; and
prints the print data at the normal print concentration if the percentage of the print data of the text format is equal to that of the print data of the image format.

14. The image forming apparatus of claim 10, further comprising:
a display unit to display the obtained print output information or the changed print concentration.

15. A computer-readable medium to contain computer-readable codes as a program to execute a method of an image forming system, the method comprising:
receiving print data from the at least one terminal device;
obtaining print output information using a type of the received print data; and
changing a print concentration of the print data according to the obtained print output information and printing the print data.

16. An image forming system comprising:
a terminal device to generate print data; and
an image forming apparatus to print the print data,
wherein print output information is obtained using a type of the print data, and a print concentration is changed according to the print output information such that the image forming apparatus prints the print data according to the changed print concentration.

17. The image forming system of claim 16, wherein the terminal device transmits the print output information to the image forming apparatus.

18. The image forming system of claim 16, wherein the image forming apparatus obtains the print output information using type of previous print data, and changes the print concentration according to the print output information and the type of the print data.

19. The image forming system of claim 16, wherein:
the terminal device comprises a plurality of terminal devices;
the print output information is obtained to correspond to each of the terminal devices to generate the print data; and
the image forming apparatus prints the print data according to the print information to the corresponding terminal device when receiving the print data from the corresponding terminal device.

20. The image forming system of claim 16, wherein:
the terminal device comprises a plurality of terminal devices;
the print output information comprises a plurality of print output information to correspond to the respective terminal devices; and
the image forming apparatus prints the print data according to the corresponding print output information.

21. An image forming apparatus comprising:
a printing unit to print current print data; and
a control unit to obtain print output information according to one or more types of one or more previous print data, to change a print concentration according to the print output information and a type of the current print data, and to control the printing unit to print the print data according to the changed print concentration.

22. The image forming apparatus of claim 21, wherein the type of the print data comprises one of the one or more types of the one or more previous print data, and the print output information comprises a ratio between the one or more types of the one or more previous print data which have been printed.

23. The image forming apparatus of claim 21, wherein the one or more types of the one or more previous print data comprises at least one of a dark mode, a middle mode, and a light mode each to represent one of density, amount, and concentration of a developer or an ink.

24. The image forming apparatus of claim 21, wherein:
the previous print data comprises first print data received from a first terminal device, and second print data received from a second terminal device;
the print output information comprises first print output information to correspond to the first print data and the first terminal device and second print output information to correspond to the second print data and the second terminal device; and
the control unit controls the printing unit to print the current print data according to the first print information and the type of the current data when the current print data is received from the first terminal device, and to print the current print data according to the second print information and the type of the current data when the current print data is received from the second terminal device.

25. The image forming apparatus of claim 21, wherein the control unit receives the current from one of plurality of terminal devices, and controls the printing unit to print the current print data according to the type of the current print data and the print output information to correspond to the one of the plurality of terminal devices.
